(19) United States
(12) Patent Application Publication
(10) Pub. No.: US 2006/0192022 A1
(43) Pub. Date: Aug. 31, 2006

(54) HVAC controller with removable instruction card

(76) Inventors: Eric J. Barton, Eden Prairie, MN (US); Robert D. Juntunen, Minnetonka, MN (US); Patrick C. Tessier, Oakdale, MN (US); Cary Leen, Hammond, WI (US); Arnie P. Kalla, Maple Grove, MN (US); Paul Meyers, Fishers, IN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/069,522

(22) Filed: Feb. 28, 2005

(51) Int. Cl. G05D 23/00

(52) U.S. Cl. 236/94; 236/51

(57) ABSTRACT

HVAC controllers can include at least some written instructions on, in or near the HVAC controller. In some instances, an HVAC controller can include a wall plate, a controller module that is releasably securable to the wall plate, and an instruction card slot that is disposed between the wall plate and the controller module. In some instances, a removable, slide-out instruction card may be disposed within the instruction card slot.

### TECHNICAL FIELD

The present invention generally relates to the field of controllers, and more specifically to HVAC and other controllers.

### BACKGROUND

There are a wide variety of controllers in use today including, for example, HVAC controllers, security system controllers, lawn sprinkler controllers, lighting system controllers, as well as many other types of controllers. HVAC controllers, for example, are employed to monitor and, if necessary, control various environmental conditions within a home, office, or other enclosed space. Such devices are useful in regulating any number of environmental conditions within a particular space including for example, temperature, humidity, venting, air quality, etc.

In many cases, such controllers often include a microprocessor and/or other circuitry that interacts with components in the system. For example, and again with reference to an HVAC controller, a thermostat may interact with a temperature, humidity and/or other sensing device, and control a heater, a blower, a compressor, a vent, a humidifier and/or other component to help control the temperature, humidity and/or other environmental parameters within a building.

Many controllers are equipped with a user interface that allows a user to interact, monitor and/or adjust one or more parameters controlled by the system. With more modern designs, the user interface may include a liquid crystal display (LCD) panel or the like inset within a housing. The user interface may permit, for example, the user to program the controller to activate, for example, on a certain schedule determined by the user.

For HVAC and other controllers, significant energy and/or other savings may be achieved by properly using and/or programming the controller. For example, energy savings may be achieved when an HVAC controller has been properly programmed to permit setbacks when the building is not occupied, or in other circumstances in which temperature setbacks can be tolerated.

While many controllers, including HVAC controllers, have become increasingly more intuitive to operate and/or program via enhanced user interfaces, some users may still need help, such as through written instructions, to properly use and/or program their controllers. In many cases, however, the owner's manual or other documentation for a controller is not always immediately available to the user when the user desires to interact with the controller. As such, and in many cases, the user simply does not operate the controller properly and/or gain the advantages of some of the functions provided by the controller.

To help avoid this, some controllers include a flip-down door upon which helpful instructions may be printed. However, as design considerations have dictated larger, more interactive user interfaces such as larger display panels, touch screens, and the like, there is less and less room available for such flip-down doors. Therefore, a need remains for a controller that makes at least some written operating and/or programming instructions available to the user without having to provide a flip down door with instructions printed thereon.

### SUMMARY

The present invention generally relates to controllers, and more specifically, to controllers that make at least some written operating and/or programming instructions available to the user without having to provide a flip down door with instructions printed thereon.

In one illustrative embodiment, a thermostat is provided that includes a housing, an instruction card receiving slot that is formed by or within the housing, and an instruction card that is adapted to be slid into the instruction card receiving slot. In some embodiments, the instruction card receiving slot is formed, at least in part, by one or more instruction card retention tabs of the housing. In other embodiments, the instruction card receiving slot is more like a pocket. It is contemplated that the instruction card receiving slot may extend through the top side, and/or one of the lateral sides of the thermostat.

In some cases, at least part of the instruction card can be adapted to extend out of the instruction card receiving slot when the instruction card is fully inserted into the instruction card receiving slot. The part of the instruction card that is adapted to extend out of the instruction card receiving slot may include a tab. In some cases, the housing can include a top side that faces up when the thermostat is mounted to a vertical surface such as a wall, and the tab may extend up past the top side of the thermostat. In other cases, the housing may have a top side, a bottom side and two lateral sides, and the tab may extend out past at least one of the lateral sides of the thermostat.

In some illustrative embodiments, the controller may include a wall plate, and a controller module that is adapted to be releasably securable to the wall plate. The wall plate is adapted to be mounted to a wall or other surface. The instruction card receiving slot may be formed or otherwise attached to the controller module, or the wall plate, as desired. When the instruction card slot is formed or otherwise attached to the controller module, and when the controller module is released or removed from the wall plate, the instruction card may accompany the control module. This may be desirable when, for example, the control module is adapted for arm chair programming. In other cases, the instruction card may remain with the wall plate.

Many controllers include one or more electrical components and/or circuit boards within a housing. In some cases, the instruction card receiving slot may be adapted to prevent the instruction card from engaging the one or more electrical components and/or circuit boards when the instruction card is received by the instruction card receiving slot. This, however, is not required. However, when so provided, this may help protect the one or more electrical components and/or circuit boards from dirt, debris as well as possible mechanical and/or electrical faults due to contact with the instruction card.

The above summary of the present invention is not intended to describe each disclosed embodiment or every implementation of the present invention. The Figures, Detailed Description and Examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a perspective view of an HVAC controller module and wall plate in accordance with an illustrative embodiment of the present invention;

FIG. 2 is a view of the rear of the HVAC controller module of FIG. 1;

FIG. 3 is a top view of the HVAC controller module of FIG. 1;

FIG. 4 is a closer view of a portion of the HVAC controller module of FIG. 1;

FIG. 5 is a view of the rear of an HVAC controller module in accordance with an illustrative embodiment of the present invention;

FIG. 6 is a front view of the wall plate of FIG. 1;

FIG. 7 is a partial cross-section of the HVAC controller module and wall plate of FIG. 1;

FIG. 8 is a partial cross-section of the HVAC controller module and wall plate of FIG. 1;

FIG. 9 is a view of FIG. 8 including an instruction card in accordance with an illustrative embodiment of the present invention;

FIG. 10 is a view of a wall plate in accordance with an illustrative embodiment of the present invention; and

FIG. 11 is a perspective view of a removable instruction card in accordance with an illustrative embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

Generally, the present invention relates to providing instructions to controllers that have a user interface. Such controllers can be used in a variety of systems such as, for example, HVAC systems, sprinkler systems, security systems, lighting systems, and the like. Many of the Figures depict HVAC controllers. While the present invention is not so limited, an appreciation of various aspects of the invention will be gained through a discussion of the examples provided below.

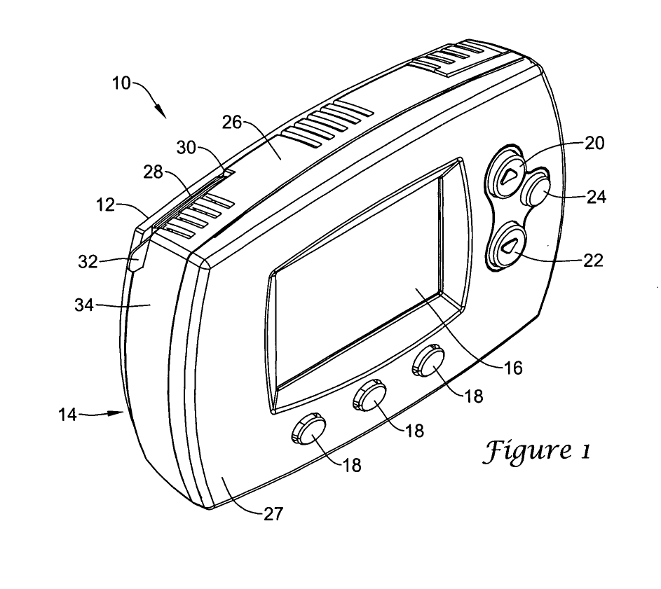

FIG. 1 is a perspective view of an illustrative HVAC controller 10. HVAC controller 10 includes a wall plate 12 and a controller module 14. Wall plate 12 may be adapted for securement to a vertical wall surface and thus may include several mounting apertures (not seen in FIG. 1). In some cases, wall plate 12 may also include leveling surfaces (not seen in FIG. 1) that aid in leveling wall plate 12 prior to securement. Wall plate 12 also can provide for electrical communication between controller module 14 and a remote HVAC system, i.e. furnace, boiler, air conditioner, humidifier, air purifier and the like.

Wall plate 12 may be adapted to releasably secure controller module 14 to wall plate 12. In some instances, controller module 14 may be secured to wall plate 12 such that wall plate 12 securely holds controller module 14 but permits controller module 14 to be relatively easily removed from wall plate 12 and subsequently returned to wall plate 12. In some instances, it may be desirable to temporarily remove controller module 14 from wall plate 12 in order to, for example, adjust or edit programmed values such as temperature set points, schedules, etc., within controller module 14. This feature may permit a user to, for example, remove controller module 14 from wall plate 12 and to sit in a comfortable arm chair while programming controller module 14 or while adjusting a pre-existing program within controller module 14.

The illustrative controller module 14 includes a display 16. Display 16 is an LCD display, which may be used to display alphanumeric data such as temperatures, times and dates. In some instances, controller module 14 may include several buttons 18 that may, for example, be used to help program and/or otherwise control controller module 14. Buttons 18 can be used to select among particular programming features. In some cases, controller module 14 may also include an up button 20 and a down button 22. Up button 20 and down button 22 may be used to either raise or lower, respectively, a value for a selected parameter. In some instances, controller module 14 may also include a hold button 24 that can be used to temporarily select a new temperature set point.

In the illustrative embodiment, controller module 14 includes software and/or circuitry adapted to retain a program including a variety of operating information as well as to provide appropriate communication with accessible HVAC equipment.

It is important to note that each of buttons 18, 20, 22 and 24, and display 16 are merely illustrative. In other embodiments, controller module 14 may include additional or fewer buttons. In some embodiments, controller module 14 may include no buttons at all, as display 16 may be, for example, a touch-screen display that can provide soft buttons on the display 16 that can be used for programming and/or running controller module 14.

Controller module 14 may be seen as including a housing 26. In some instances, as illustrated, controller module 14 may also include a front plate 27 that secures to housing 26. In some instances, there may be manufacturing advantages to separately providing front plate 27. Front plate 27 may include openings corresponding to display 16, buttons 18, up button 20, down button 22, and hold button 24.

FIG. 1 hints at a particularly interesting feature of HVAC controller 10. HVAC controller 10 includes a removable, slide-out instruction card 28 disposed within slot 30. Slot 30 will be discussed in greater detail with respect to subsequent Figures. As shown, it can be seen that instruction card 28 may be folded accordion-style. When so provided, this may provide greater information capacity on instruction card 28. In some instances, instruction card 28 may simply be a flat substrate.

In some instance, instruction card 28 may include a tab 32 that, in the illustrated embodiment, extends beyond a lateral side 34 of housing 26. It is contemplated that the tab 32 may alternatively, or in addition to, extend above the top of the housing 26. In some instances, tab 32 may serve to identify instruction card 28. It can be seen in FIG. 1 that a user could easily extend a finger along side 34 of housing 26, contact tab 32, and hence lift instruction card 28 out of slot 30. In some instances (not illustrated), tab 32 may be positioned along an upper surface of instruction card 28, and in these circumstances instruction card 28 may be removed by grasping tab 32 and pulling upward.

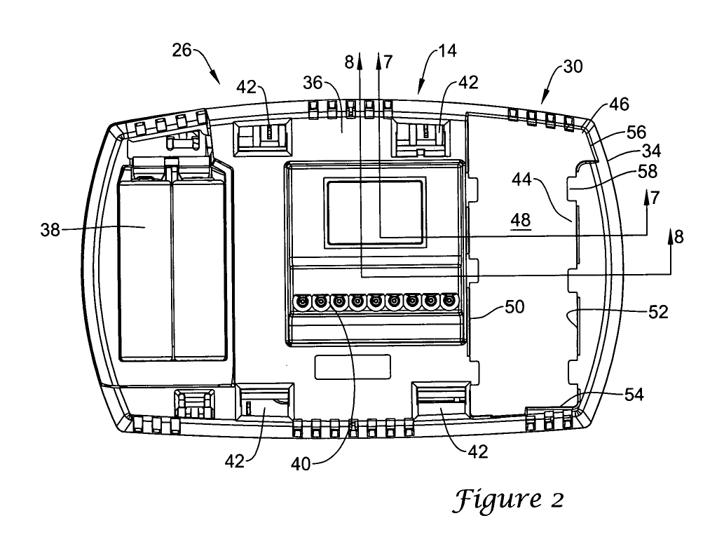

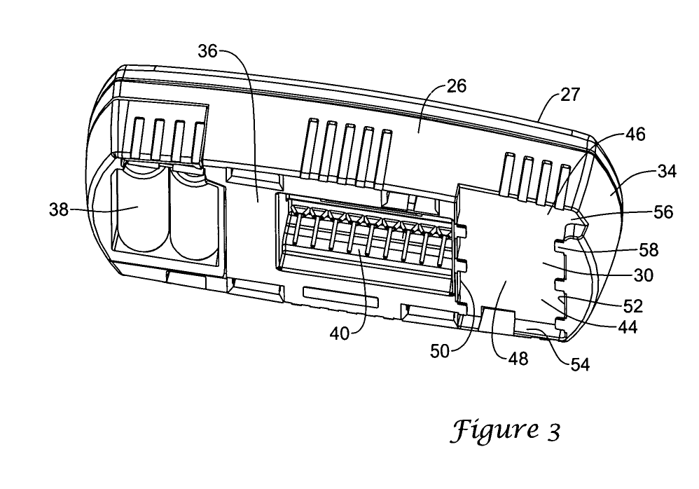

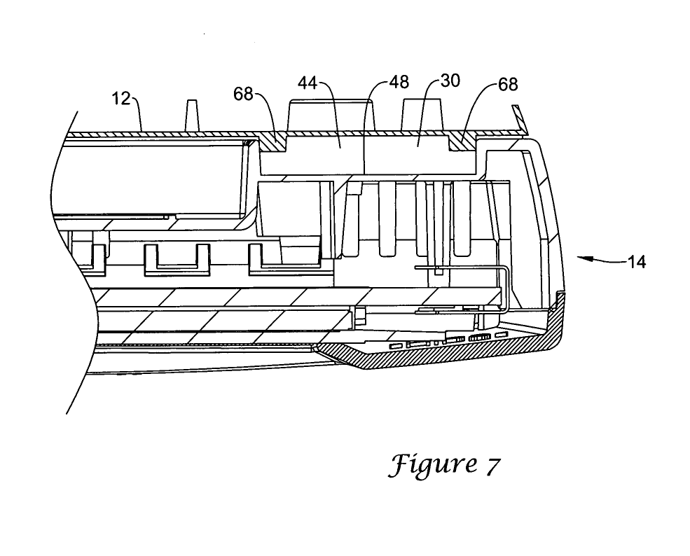

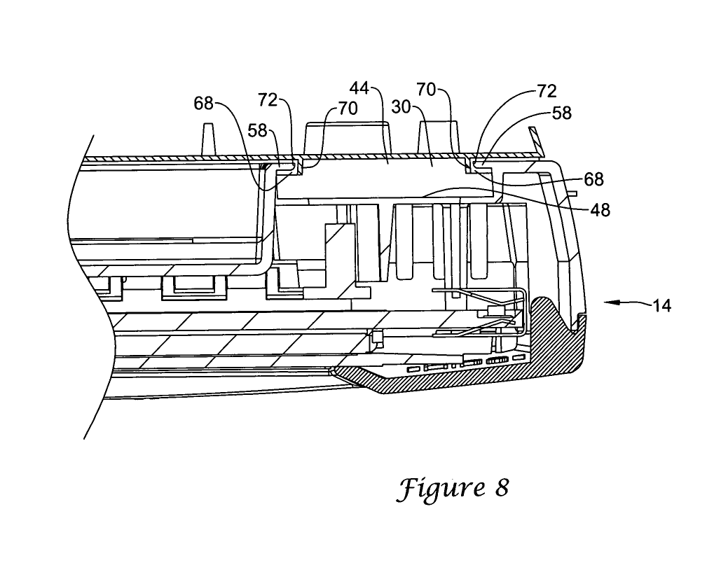

FIGS. 2 and 3 illustrate a back surface 36 of housing 26. Between FIG. 2, which is a rear view of housing 26, and FIG. 3, which is an angled perspective rear view of housing 26, one can obtain a clear picture of slot 30 as well as some other features. FIG. 2 also shows the orientation of the cross-sections represented by FIGS. 7 and 8, which will be discussed subsequently. While FIGS. 7 and 8 are actually cross-sections of FIG. 1, including controller module 14 as well as wall plate 12, the section orientation is provided with respect to FIG. 2 for clarity.

In some instances, housing 26 is configured to accommodate a battery pack 38. The illustrative HVAC controller 10 includes one or more batteries contained within battery pack 38 in order to provide sufficient current to operate HVAC controller 10. In some instances, HVAC controller 10 draws operating power from the HVAC equipment it controls, and the batteries may be included merely as back-up protection. In some cases, HVAC controller 10 is powered by the HVAC equipment it controls and no battery back-up is included.

In the illustrative embodiment, housing 26 is configured to accommodate an electrical connector 40. As best seen in FIG. 3, electrical connector 40 may actually include several distinct male connectors that are adapted to mate with corresponding female connectors that can be disposed on wall plate 12.

In some cases, housing 26 may include structure intended to releasably secure controller module 14 (FIG. 1) to wall plate 12 (FIG. 1). In the illustrated embodiment, for example, housing 26 includes a total of four mounting apertures 42 that are adapted to accommodate a total of four mounting protrusions 64 provided by wall plate 12 (FIG. 1, 6).

Slot 30 includes a recess 44 that has an upper opening 46, a bottom surface 48, a first side surface 50, a second side surface 52, and a lower surface 54. In some instances, it is contemplated that recess 44 may extend all the way to side 34 of housing 26. In such cases, second side surface 52 may be absent. In some instances, slot 30 may include a side opening or slot 56 that is configured to accommodate tab 32 (FIG. 1). In some cases, recess 44 may have a depth of about 1/10inch while side opening or slot 56 has a height of about ⅓inch.

In the illustrative embodiment shown in FIG. 2, slot 30 includes six instruction card retention tabs 58, with three disposed along first side surface 50 and three disposed along second side surface 52 of the instruction card receiving slot 30. In some cases, instruction card retention tabs 58 may be molded using telescoping shutoffs. By locating parting lines on a side of instruction card retention tabs 58 away from where instruction card retention tabs 58 may contact instruction card 28 (FIG. 1), any flash created during molding will not interfere with insertion and removal of instruction card 28.

It can be seen that each of the instruction card retention tabs 58 extend at least substantially parallel with bottom surface 48, and that instruction card retention tabs 58 function in combination with recess 44 to form slot 30 and to provide for releasable, slide-out instruction card 28 (FIG. 1).

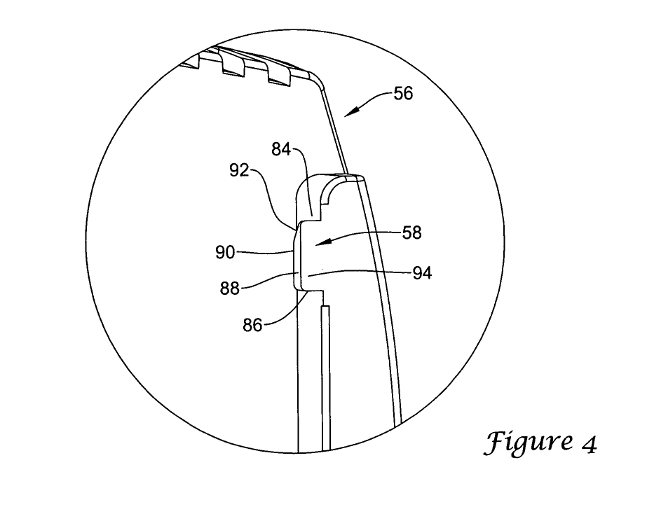

FIG. 4 is a perspective view showing a closer look at a single illustrative instruction card retention tab 58. In some instances, each of the instruction card retention tabs 58, if more than one are present, may be shaped similarly or even identically to that shown in FIG. 4. The particular instruction card retention tab 58 illustrated is one positioned just below side opening or relief 56 (discussed with respect to FIG. 3). Instruction card retention tab 58 has a leading edge 84 and a trailing edge 86. It can be seen that leading edge 84 will be the first portion of instruction card retention tab 58 that may be contacted by instruction card 28 (FIG. 1) when inserted. Instruction card retention tab 58 has an inner edge 88 that extends over recess 44 (FIG. 3).

Instruction card retention tab 58 includes a slot side 90 that is closest to bottom surface 48 (FIG. 3) and that includes a beveled profile portion 92. It can be seen that slot side 90 and beveled profile portion 92 in combination can help to guide instruction card 28 (FIG. 1) into instruction card slot 30 (FIG. 3). Instruction card retention tab 58 also includes a back surface 94.

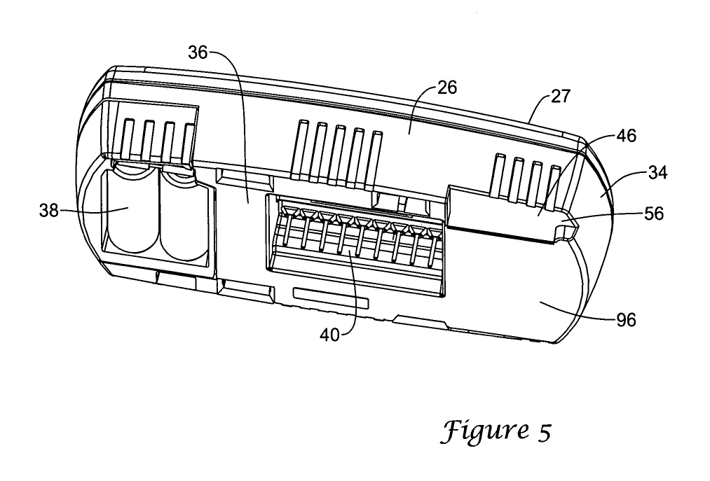

FIG. 5 shows an alternate controller module housing 26 in accordance with another illustrative embodiment of the present invention. Rather than simply including one or more instruction card retention tabs 58 (FIG. 3), instruction card slot 30 (FIG. 3) is formed using a full rear plate 96. In some instances, rear plate 96 may be an integral part of housing 26. In other cases, rear plate 96 may be separately formed and subsequently added, as desired. In addition, in some cases, the rear plate 96 may include one or more holes therein, which may reduce material costs.

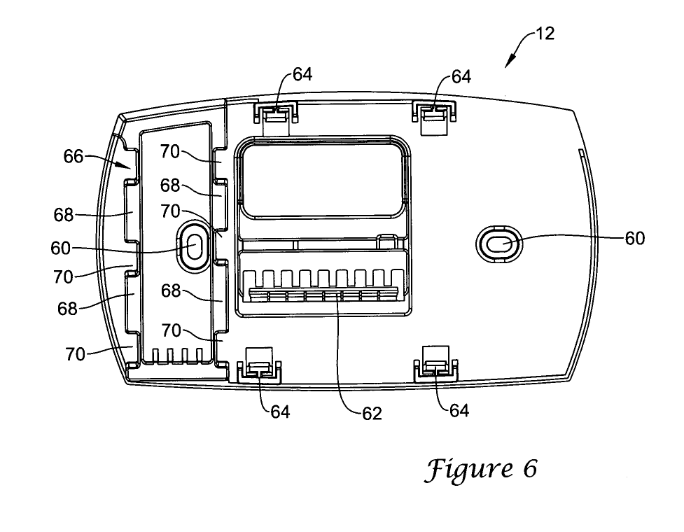

FIG. 6 is a front view of wall plate 12. As discussed above, wall plate 12 may be adapted for securement to a vertical wall surface. As such, wall plate 12 may include several mounting apertures 60. In some instances, one mounting aperture 60 is oriented vertically while the other is oriented horizontally. In some cases, vertically oriented mounting aperture 60 provides for greater adjustment in leveling wall plate 12.

As noted above, housing 36 may include an electrical connector 40 (FIGS. 2, 3) including several distinct male connectors, which are adapted to mate with corresponding electrical connector 62. In the illustrated embodiment, electrical connector 62 includes structure adapted to hold several female connectors (not illustrated) that are adapted to mate with the male members of electrical connector 40.

Wall plate 12 includes a total of four mounting protrusions 64 that are adapted to cooperate with mounting apertures 42 (FIGS. 2, 3) to releasably secure controller module 14 (FIG. 1) to wall plate 12. In some instances, the upper pair of mounting protrusions 64 may double as a leveling surface against which wall plate 12 may be leveled by providing a bubble level or other similar level across the leveling surface.

The illustrative wall plate 12 includes a raised portion 66 that in some instances can cooperate with slot 30 (FIGS. 2, 3) to permit easy removal and insertion of instruction card 28 (FIG. 1). In the illustrative embodiment, raised portion 66 is configured to accommodate instruction card retention tabs 58 (FIGS. 2, 3), as raised portion 66 includes several widened portions 68 and several narrowed portions 70. As can be imagined by flipping FIG. 6 and superimposing it onto FIG. 2, widened portions 68 fit down into recess 44 in between adjacent instruction card retention tabs 58 while instruction card retention tabs 58 fit into appropriately aligned narrowed portions 70. The relationship between slot 30, raised portion 66 and instruction card 28 (FIG. 1) is best seen in FIGS. 7, 8 and 9.

FIG. 7 is a partial cross-section of FIG. 1 looking upward towards upper opening 46 (FIGS. 2, 3). For clarity, this orientation is illustrated by the cross-section line 7-7 shown in FIG. 2. In this view, instruction card 28 (FIG. 1) has been removed for clarity. In FIG. 7, wall plate 12 is seen to include a widened portion 68 extending into recess 44 along either side of slot 30. Section 7-7 is taken through widened portion 68 (with respect to wall plate 12). Section 8-8, however, is taken through an adjacent narrowed portion 70 (with respect to wall plate 12).

FIG. 8 is a partial cross-section of FIG. 1 looking upward towards upper opening 46 (FIGS. 2, 3), with instruction card 28 (FIG. 1) removed for clarity. This orientation is illustrated by the cross-section line 8-8 shown in FIG. 2. Wall plate 12 is seen to include a narrowed portion 70 extending into recess 44 along either side of slot 30. Slot 30 includes instruction card retention tabs 58, with one on either side of slot 30. In some instances, as illustrated, instruction card retention tabs 58 may include a beveled, rounded, angled or otherwise non-square surface 72 positioned where instruction card retention tabs 58 are most likely to interact with instruction card 28. Wall plate 12 also shows elements of adjacent widened portions 68, visible underneath instruction card retention tabs 58.

It should be noted that narrowed portion 70 extends into slot 30 such that a distance between narrowed portion 70 (and hence raised portion 66) and bottom surface 48 may be less than or equal to a distance between instruction card retention tab 58 and bottom surface 48. Consequently, raised portion 66 can be seen as cooperating with slot 30 to permit easily insertion and removal of instruction card 28 (FIG. 1), as raised portion 66 will, in some instances, hold instruction card 28 away from instruction card retention tabs 58.

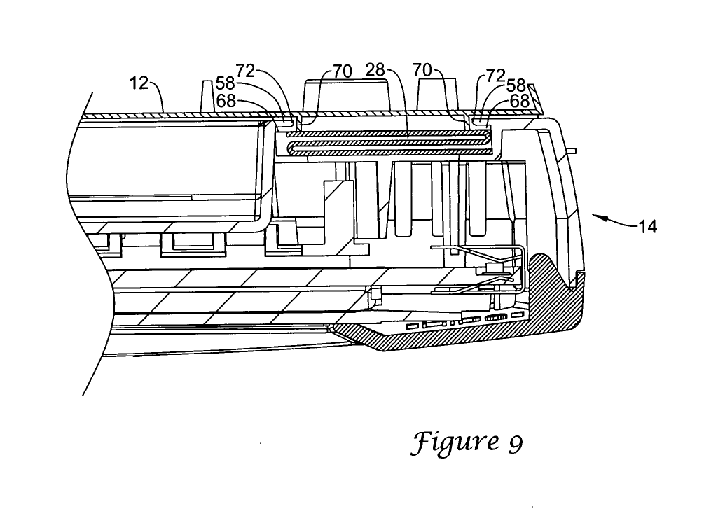

FIG. 9 is the same cross-section as FIG. 8, but FIG. 9 includes instruction card 28. FIG. 9 clearly shows that widened portions 68 and narrowed portions 70 hold instruction card 28 away from instruction card retention tabs 58 and thus helps permits easy removal and insertion of instruction card 28 when controller module 14 is secured to wall plate 12. However, when controller module 14 has been temporarily removed from wall plate 12, instruction card retention tabs 58 secure instruction card 28 yet help permit easy removal of instruction card 28.

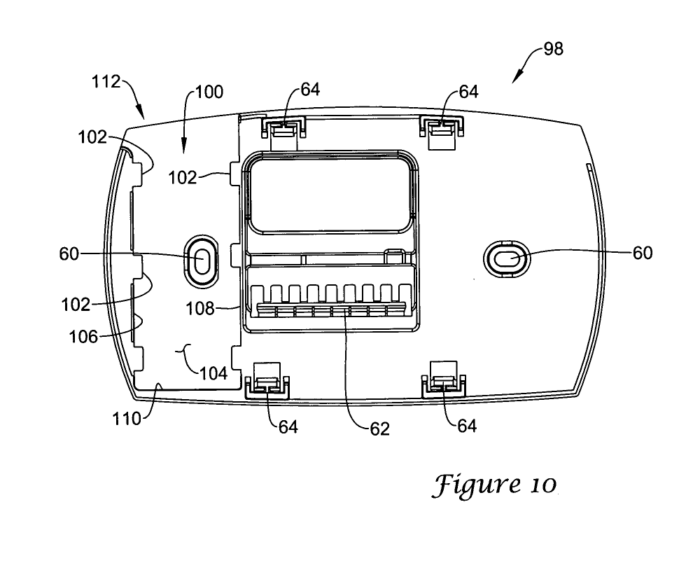

FIG. 10 illustrates a wall plate 98 in accordance with another embodiment of the present invention. Rather than placing the instruction card slot on or in a back surface or portion of controller module 14 (FIG. 1), FIG. 10 shows that an instruction card receiving slot 100 may instead be formed within or by wall plate 98. Instruction card receiving slot 100 includes several instruction card retention tabs 102 aligned along either side, a bottom surface 104, a left side 106, a right side 108 and a lower surface 110. Instruction card slot 100 may also include an upper opening 112.

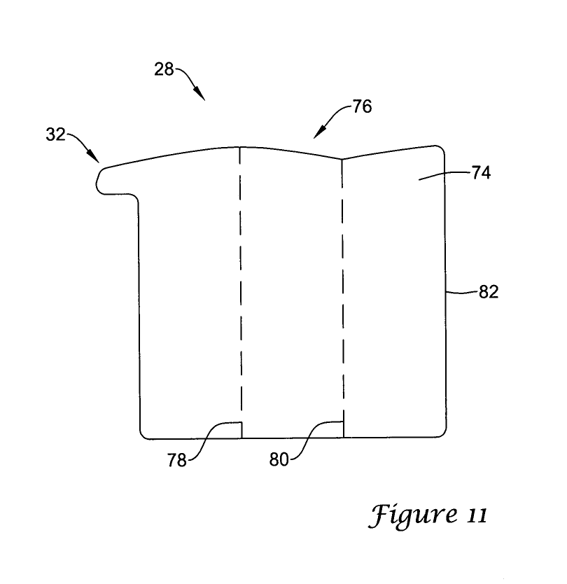

Instruction card 28 may encompass a variety of substrates, shapes, and written and/or printed information and/or graphics. FIG. 11 shows an illustrative but non-limiting example of a substrate 74. Substrate 74 can be seen to include tab 32, a multi-curved top surface 76, and first and second fold lines 78 and 80. When substrate 74 is folded accordion-style such that first fold line 78 aligns with right edge 82, multi-curved top surface 76 will approximate the shape of an upper portion of housing 26 (FIG. 1).

In some instances, depending on the characteristics of substrate 74, first and second fold lines 78 and 80 may be printed lines showing where substrate 74 should be folded. In some instances, substrate 74 may include no fold lines, one fold line, or even three or more fold lines. In some cases, first and second fold lines 78 and 80 may represent creases, scoring or even perforations. Substrate 74 may be formed from any suitable material that may be printed on and can withstand folding. One example of a suitable material is 80 pound Sterling Ultra Gloss Cover. In some instances, instruction card 28 may be formed of a rigid plastic material and thus may not include fold lines 78 and 80.

Instruction card 28 may be printed or otherwise provided with any suitable information. In some instances, instruction card 28 may include rudimentary programming instructions that would permit a user to, for example, set the date and time and to edit an HVAC control schedule. In other instances, for example, if HVAC controller 10 is not programmable, instruction card 28 may be printed with operating instructions, suggested maintenance schedules such as filter replacement, and the like.

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

We claim:

1. A thermostat, comprising:
a housing;
an instruction card receiving slot formed by the housing; and
an instruction card, at least part of the instruction card sized to slide in and out of the instruction card receiving slot.

2. The thermostat of claim 1, wherein at least part of the instruction card is adapted to extend out of the instruction card receiving slot when the instruction card is fully inserted into the instruction card receiving slot.

3. The thermostat of claim 2 wherein the at least part of the instruction card that is adapted to extend out of the instruction card receiving slot includes a tab.

4. The thermostat of claim 3 wherein the housing has a top side that faces up when the thermostat is mounted to a wall or the like, the tab extending up past the top side of the thermostat.

5. The thermostat of claim 3 wherein the housing has a top side, a bottom side and two lateral sides, the tab extending out past at least one of the lateral sides of the thermostat.

6. The thermostat of claim 1 wherein the housing has a top side that faces up when the thermostat is mounted to a wall or the like, the instruction card receiving slot extending through the top side of the thermostat.

7. The thermostat of claim 6 wherein the housing further includes two lateral sides, and wherein the instruction card includes a tab that is adapted to extend out past at least one of the lateral sides of the thermostat when the instruction card is fully inserted into the instruction card receiving slot.

8. The thermostat of claim 1 wherein the instruction card receiving slot is formed, at least in part, by one or more instruction card retention tabs of the housing.

9. An HVAC controller, comprising:
a wall plate; and
a controller module adapted to be releasably securable to the wall plate, the controller module forming at least part of an instruction card receiving slot for receiving an instruction card.

10. The HVAC controller of claim 9, wherein the instruction card and instruction card receiving slot are adapted so that the instruction card can be easily fully removed from the instruction card receiving slot.

11. The HVAC controller of claim 9 wherein the controller module includes one or more electrical components and/or circuit boards, and wherein the instruction card receiving slot is adapted to prevent the instruction card from engaging the one or more electrical components and/or circuit boards when the instruction card is received by the instruction card receiving slot.

12. An HVAC controller, comprising:
a wall plate;
a controller module releasably securable to the wall plate; and
an instruction card slot disposed between the wall plate and the controller module.

13. The HVAC controller of claim 12, wherein the controller module is releasably securable to the wall plate such that a user may remove the controller module from the wall plate and subsequently secure the controller module to the wall plate.

14. The HVAC controller of claim 12, wherein the controller module comprises an LCD display.

15. The HVAC controller of claim 12, wherein the controller module comprises user-programmable software or circuitry.

16. The HVAC controller of claim 12, further comprising a removable, slide-out instruction card disposed within the instruction card slot.

17. The HVAC controller of claim 16, wherein the instruction card slot is adapted to releasably secure the instruction card when the controller module has been released from the wall plate.

18. The HVAC controller of claim 12, wherein the controller module comprises a housing, and the instruction card slot comprises a recess formed within a back surface of the controller module housing.

19. The HVAC controller of claim 18, wherein the recess comprises a bottom surface, a lower surface, a first side surface, a second side surface and an upper opening.

20. The HVAC controller of claim 19, wherein the upper opening has a length that is about equal to a width of the bottom surface of the recess and wherein the first and second side surfaces are at least substantially parallel.

21. The HVAC controller of claim 19, wherein the instruction card slot further comprises at least one instruction card retention tab extending at least substantially parallel to the bottom surface of the recess.

22. The HVAC controller of claim 21, wherein the at least one instruction card retention tab comprises a rounded or angled profile.

23. The HVAC controller of claim 21, wherein the at least one instruction card retention tab comprises a plurality of instruction card retention tabs.

24. The HVAC controller of claim 23, wherein the plurality of instruction card retention tabs are spaced along either side of the recess.

25. The HVAC controller of claim 21, wherein the wall plate comprises a raised portion that extends into the instruction card slot at least as far as the at least one instruction card retention tab.

26. The HVAC controller of claim 25, wherein the raised portion is configured to accommodate the at least one instruction card retention tab.

27. The HVAC controller of claim 25, wherein the raised portion of the wall plate is at least substantially parallel with the bottom surface of the recess and a distance between the raised portion and the bottom surface of the recess is less than or substantially equal to a distance between the at least one instruction card retention tab and the bottom surface of the recess when the controller module is releasably secured to the wall plate.

28. A programmable thermostat, comprising:
a wall plate;
a thermostat module releasably secured to the wall plate, the thermostat module comprising an LCD display;
an instruction card slot disposed between the wall plate and the thermostat module;
a removable, slide-out instruction card disposed within the instruction card slot; and
wherein the instruction card slot is adapted to releasably secure the removable, slide-out instruction card when the thermostat module is not attached to the wall plate.

29. The programmable thermostat of claim 28, wherein the thermostat module further comprises a housing, and the instruction card slot includes a recess formed within the housing.

30. The programmable thermostat of claim 29, wherein the wall plate comprises a raised portion that is arranged and configured to cooperate with the recess to help guide the instruction card into the instruction card slot.

31. The programmable thermostat of claim 28, wherein the instruction card comprises printed information on a substrate folded accordion-style to fit within the instruction card slot.

32. The programmable thermostat of claim 31, wherein the instruction card further comprises a tab configured to extend beyond an edge of the programmable thermostat when the instruction card is disposed within the instruction card slot.

33. The programmable thermostat of claim 32, wherein the recess further comprises a relief portion configured to accommodate the instruction card tab.
